(19) United States
(12) Patent Application Publication
(10) Pub. No.: US 2014/0126848 A1
(43) Pub. Date: May 8, 2014

(54) FRICTION AND WEAR REDUCTION IN CRYOGENIC MECHANISMS AND OTHER SYSTEMS

(71) Applicant: Raytheon Company, Waltham, MA (US)

(72) Inventors: Daniel Vukobratovich, Tucson, AZ (US); James E. Scroggin, McKinney, TX (US); Konstantine J. Christopoulos, Redondo Beach, CA (US)

(73) Assignee: Raytheon Company, Waltham, MA (US)

(21) Appl. No.: 14/071,970

(22) Filed: Nov. 5, 2013

Related U.S. Application Data
(60) Provisional application No. 61/723,071, filed on Nov. 6, 2012.

(51) Int. Cl. F16C 17/04

(52) U.S. Cl. CPC F16C 17/04
USPC 384/420

(57) ABSTRACT

An apparatus includes a first component having a first surface and a second component having a second surface. The first surface includes sputtered gold, and the second surface includes a stainless steel alloy. The first surface is configured to contact the second surface, and one of the components is configured to move against another of the components. The stainless steel alloy could consist of a UNS 21800/AISI Type S21800 metal. The sputtered gold could include ion sputtered gold, and the sputtered gold could have a thickness of about 1 micron. The first component could include a first blade of an adjustable aperture mechanism, where the adjustable aperture mechanism also includes a second blade. The second component could include a first plate of the adjustable aperture mechanism, where the adjustable aperture mechanism further includes a second plate. The blades can be configured to move within a space between the plates.

### CROSS-REFERENCE TO RELATED APPLICATION AND PRIORITY CLAIM

This application claims priority under 35 U.S.C. §119(e) to U.S. Provisional Patent Application No. 61/723,071 filed on Nov. 6, 2012. This provisional application is hereby incorporated by reference in its entirety.

### TECHNICAL FIELD

This disclosure is directed generally to friction and wear reduction. More specifically, this disclosure relates to friction and wear reduction in cryogenic mechanisms and other systems.

### BACKGROUND

Different types of devices include components that move against each other, creating various problems. For example, friction produces heat, which among other things can make it difficult to precisely control the temperatures of the components. Also, wear of the components can cause the devices to fail over time.

Various approaches have been used to reduce friction and wear in devices, including the use of specific coatings on device components. These coatings include bonded molybdenum disulfide (MoS₂) coatings, exotic hard coatings (such as “diamond like” coatings), and hard boron carbide coatings. However, components having bonded molybdenum disulfide coatings can suffer from particulate contamination, and the friction coefficient of bonded molybdenum disulfide is higher in a vacuum than in air. Exotic hard coatings are typically expensive, have long development cycles, and have friction coefficients higher in a vacuum than in air. In addition, all of these coatings may still allow enough wear so that components fail earlier than desired. Dry film lubricants have also been used to coat device components, although their use adds additional complexity into a device.

### SUMMARY

This disclosure relates to friction and wear reduction in cryogenic mechanisms and other systems.

In a first embodiment, an apparatus includes a first component having a first surface and a second component having a second surface. The first surface includes sputtered gold, and the second surface includes a stainless steel alloy. The first surface is configured to contact the second surface, and one of the components is configured to move against another of the components.

In a second embodiment, a method includes obtaining a first component having a first surface and obtaining a second component having a second surface. The first surface includes sputtered gold, and the second surface includes a stainless steel alloy. The method also includes placing the first surface of the first component into contact with the second surface of the second component. One of the components is configured to move against another of the components.

In a third embodiment, a method includes operating a device having a first component and a second component. The first component has a first surface with sputtered gold, and the second component has a second surface with a stainless steel alloy. The method also includes moving one of the components against another of the components while the first surface is contacting the second surface.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example device supporting friction and wear reduction in accordance with this disclosure;

FIGS. 2A through 6 illustrate an example imaging device with a variable aperture mechanism and related details in accordance with this disclosure;

FIG. 7A and 7B illustrate another example imaging device with a variable aperture mechanism and related details in accordance with this disclosure; and

FIG. 8 illustrates an example method for reducing friction and wear in cryogenic mechanisms and other systems in accordance with this disclosure.

### DETAILED DESCRIPTION

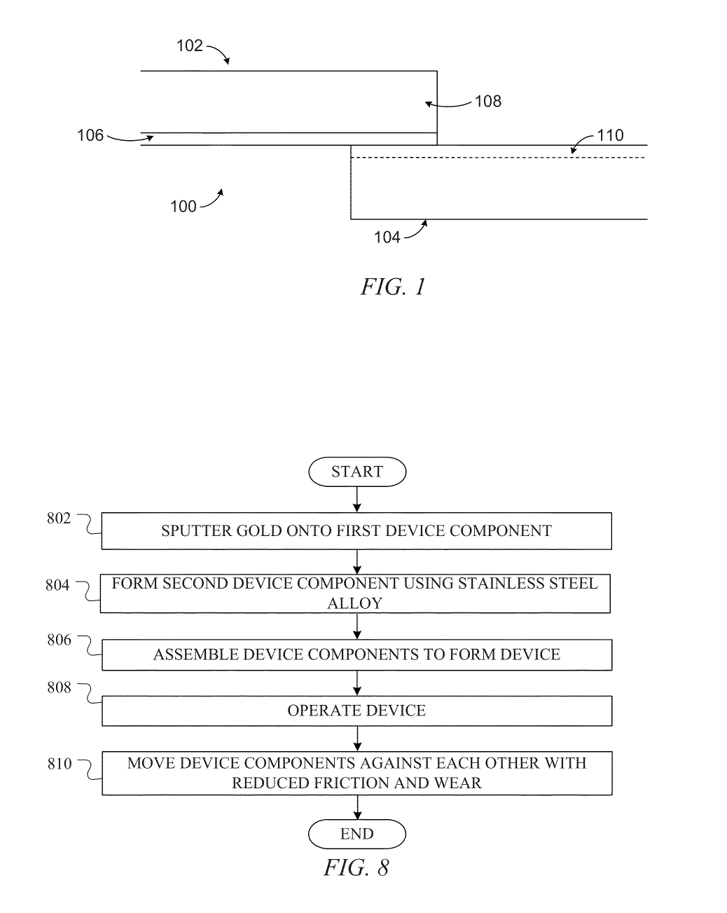

FIGS. 1 through 8, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

In general, this disclosure describes the use of dissimilar materials on different components to reduce wear and friction of those components. One component includes sputtered gold. The other component includes a stainless steel alloy such as NITRONIC 60, which is a stainless steel alloy defined by the Unified Numbering System (UNS) 21800/American Iron and Steel Institute (AISI) Type S21800 specifications. Through the use of these materials, the friction and wear on the components are reduced when the components contact one another and at least one of the components moves.

FIG. 1 illustrates an example device 100 supporting friction and wear reduction in accordance with this disclosure. As shown in FIG. 1, the device 100 includes two device components 102-104. The device 100 represents any suitable device having one or more moving parts. The device components 102-104 represent portions of any suitable device, where at least one of the device components 102-104 moves and contacts the other device component. One or both of the device components 102-104 may move while contacting the other device component.

In this example, the device component 102 includes at least one contact layer 106 and a substrate 108. Each contact layer 106 represents a layer of sputtered gold that is deposited on the substrate 108 and that contacts another device component. The substrate 108 represents any suitable structure on which at least one layer of sputtered gold can be deposited. The substrate 108 could be formed from any suitable material(s).

While shown as having a layer 106 of sputtered gold on one side, the substrate 108 could have any number of surfaces covered with sputtered gold. For instance, opposing surfaces of the substrate 108 could each have a contact layer 106 of sputtered gold, such as when both surfaces of the device component 102 will contact other component(s) of a device.

At least a portion of the device component 104 is formed using a stainless steel alloy such as NITRONIC 60. The entire device component 104 could be formed using the stainless steel alloy. Alternatively, only a portion 110 of the device component 104 may be formed from stainless steel alloy, such as the portion that contacts the device component 102.

The combination of sputtered gold on one device component and stainless steel alloy such as NITRONIC 60 on another device component significantly reduces friction between those components. As a result, less heat may be created as a result of movement by the device component(s). If one or both device components are cooled by an external cooling system (such as a cryogenic cooling system), this may help to enable more accurate control of the device component(s)' temperature(s). Moreover, this can result in less wear to one or both device components, helping to lengthen the operational lifespan of the device 100.

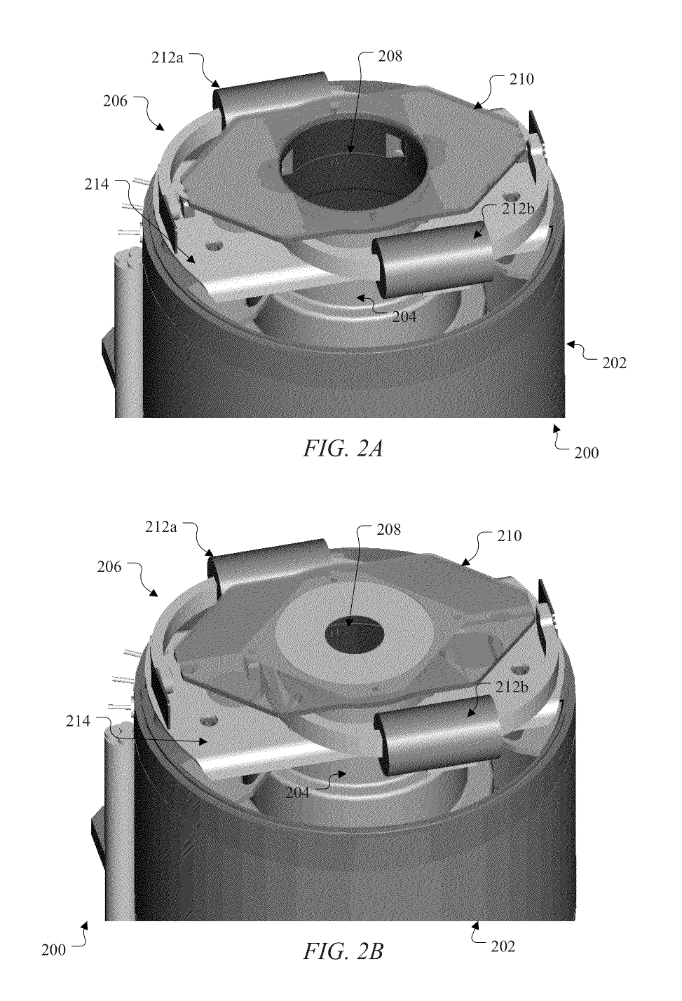

The approach described above can use sputtered gold and stainless steel alloy such as NITRONIC 60 in any suitable device or system where friction or wear reduction is desired. For example, FIGS. 2A through 7B describe variable aperture mechanisms for imaging systems, where blades of the aperture mechanism have sputtered gold and plates covering the blades have stainless steel alloy such as NITRONIC 60. The variable aperture mechanisms described below differ in the manner in which the blades are moved. In both embodiments, however, the friction and wear on the blades and plates are reduced using the combination of sputtered gold and stainless steel alloy such as NITRONIC 60. Note, however, that these materials can be used to reduce wear or friction with any other suitable components in any other suitable device or system. The use of these materials is not limited to variable aperture mechanisms or components in imaging devices.

The thickness of the sputtered gold layer (contact layer 106) can affect the amount of friction between the device components 102-104 and the wear resistance. For example, depending on the implementation, a sputtered gold layer of about one micron in thickness may provide a reduced or minimal amount of friction. Increasing the thickness to about ten microns could increase the friction coefficient by a factor of two. Decreasing the thickness to about 100 nanometers could slightly decrease the friction coefficient but increase wear dramatically.

Moreover, any suitable sputtering technique could be used to deposit the gold on a substrate. In some embodiments, a normal sputtering process can be employed to deposit nickel (such as a 300 Å thick nickel “strike”) and gold on a substrate. In one sputtering process, argon is introduced into a vacuum chamber, power is applied to the vacuum chamber, and material is removed from nickel or gold targets via bombardment by positively-charged argon ions in an argon plasma. The substrate 108 can be positioned within the plasma, resulting in deposition of the nickel or gold onto the substrate 108. Other sputtering processes, such as vacuum deposition processes, could also be used.

Note that this approach differs from conventional approaches for various reasons. For example, the use of similar materials is often preferred in cryogenic mechanisms in order to help minimize thermal expansion issues. Also, “hard” materials are often preferred for wear and friction reduction. In addition, much thicker coatings of gold or silver are often preferred due to limited service lifetime issues. All of these teach away from the use of dissimilar materials like sputtered gold and stainless steel alloy such as NITRONIC 60.

Also note that the use of gold in a sputtered form can help to enable the reduction of friction against a stainless steel alloy such as NITRONIC 60. Other forms of gold, such as electroplated gold, may provide little or no reduction in friction against a stainless steel alloy such as NITRONIC 60.

Although FIG. 1 illustrates one example of a device 100 supporting friction and wear reduction, various changes may be made to FIG. 1. For example, the size, shape, and dimensions of the various components 102-110 in the device 100 are for illustration only. Also, any suitable device can use sputtered gold and a UNS 21800/AISI Type S21800 metal or other stainless steel alloy to reduce friction and wear.

FIGS. 2A through 6 illustrate an example imaging device 200 with a variable aperture mechanism and related details in accordance with this disclosure. As shown in FIGS. 2A and 2B, the imaging device 200 includes a housing 202. The housing 202 encases and protects other components of the imaging device 200. In some embodiments, the housing 202 can engage with a cover to create a vacuum chamber within at least part of the housing 202 (although the use of a vacuum environment is not required). The housing 202 includes any suitable structure for encasing other components of an imaging device. The housing 202 could also be formed from any suitable material(s) and in any suitable manner.

The device 200 also includes a cooling system 204, a portion of which is shown here. Among other things, the cooling system 204 is used to cool portions of an aperture system 206. The cooling system 204 can cool the portions of the aperture system 206 to any suitable temperature, which could vary depending on the application. In some embodiments, for example, the cooling system 204 could cool portions of the aperture system 206 to a temperature around 100° K. The cooling system 204 includes any suitable structure for cooling one or more components, such as to cryogenic temperatures.

The aperture system 206 adjusts an opening or aperture 208 of the imaging device 200. As shown in FIG. 2A, the aperture 208 could have a larger size in one configuration, and the larger size can be defined by the aperture system 206 or by the opening of the structure below the aperture system 206 (such as a cold shield of the cooling system 204). As shown in FIG. 2B, the aperture 208 could have a smaller size in another configuration. The aperture system 206 therefore allows the device 200 to control an amount of light provided to an image sensor within the device 200. Note that any suitable aperture sizes could be supported by the aperture system 206. For example, the larger aperture size shown in FIG. 2A could represent an f/2 aperture size, while the smaller aperture size shown in FIG. 2B could represent an f/5 aperture size.

In this example, the aperture system 206 includes an aperture mechanism 210 that adjusts the size of the aperture 208. The aperture system 206 also includes multiple motors 212a-212b and a motor mount 214. As described below, the aperture mechanism 210 includes two blades that can be moved back and forth by the motors 212a-212b to adjust the size of the aperture 208. The motors 212a-212b can generate electromagnetic fields, and magnets in or coupled to the blades can be affected by the electromagnetic fields. This allows the motors 212a-212b to move the blades without actually contacting the blades. The motor mount 214 mounts the motors 212a-212b to the housing 202. In some embodiments, the housing 202, the motors 212a-212b, and the motor mount 214 could be kept at room or ambient temperature, while the aperture mechanism 210 could be kept at a cryogenic or other lower temperature. This enables the aperture mechanism 210 to be thermally isolated from the components at room or ambient temperature, even though the other components are used to adjust the aperture mechanism 210. Additional details regarding the aperture system 206 are provided below.

The imaging device 200 shown here could represent part of any suitable larger device or system. For example, the imaging device 200 could be used as part of an infrared sensor that requires the use of two aperture sizes. The imaging device 200 could also meet various specifications that conventional iris mechanisms are unable to satisfy. For instance, the aperture system 206 could operate over hundreds of thousands of actuations, such as five hundred thousand actuations or more. In addition, the aperture system 206 is able to operate effectively in vacuum environments.

The aperture system 206 can replace more complex rotary iris mechanisms (which may require numerous blades with numerous piezoelectric motors and motor drivers) with a design that uses two movable blades and two electromagnetic motors. This can simplify the design and cost of the aperture system 206. Also, the aperture mechanism 210 can be mounted directly to the cold stage of the cooling system 204, allowing improved temperature control of the aperture mechanism 210. Further, the blades of the aperture mechanism 210 can be captured inside upper and lower plates, providing a simple and physically light design that allows improved temperature control of the blades. Moreover, material selection of components within the aperture system 206 can produce good wear characteristics, neutral coefficient of thermal expansion (CTE) issues, and improved stability at cryogenic temperatures (such as by using sputtered gold on the blades and stainless steel alloy like NITRONIC 60 on the upper and lower plates covering the blades). In addition, the design of the aperture system 206 allows both large and small apertures to be supported by the same aperture system 206, helping to simplify the design of a cold shield or other structure on which the aperture system 206 is mounted.

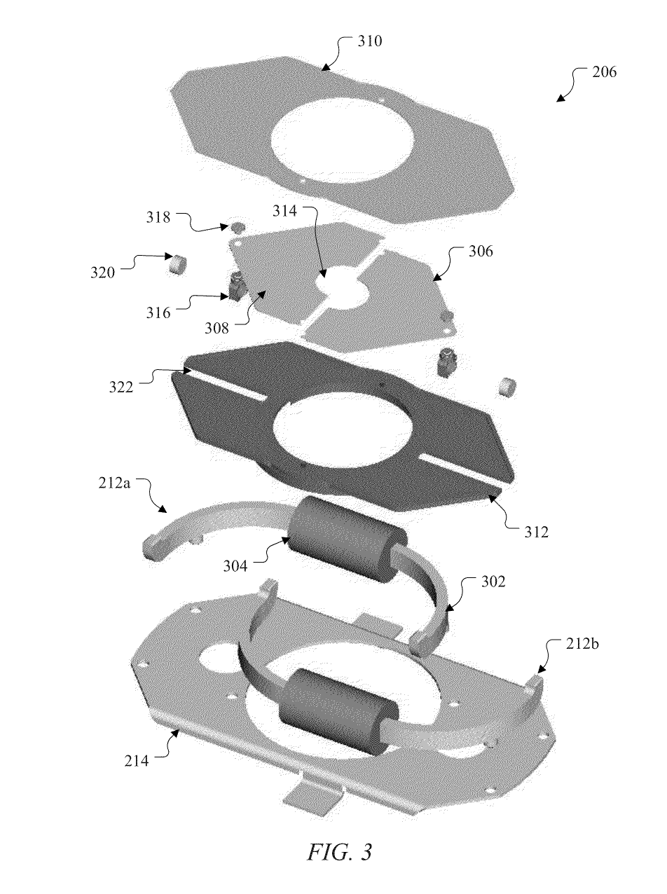

FIG. 3 illustrates one example embodiment of the aperture system 206. For ease of explanation, the aperture system 206 is described as being used in the imaging device 200 of FIGS. 2A and 2B. However, the aperture system 206 could be used in any other suitable device or system.

As shown in FIG. 3, the aperture system 206 includes the motors 212a-212b and the motor mount 214. The motors 212a-212b can be mounted on or to the motor mount 214, and the motor mount 214 can be mounted on or to the housing 202 of the imaging device 200. This secures the motors 212a-212b in place within the housing 202. In this example, each motor 212a-212b represents an electromagnet having a core 302 and a coil 304. The core 302 represents any suitable core that can be used to create an electromagnetic field, such as an iron core. Current flowing through the coil 304 creates an electromagnetic field in the core 302. The direction of current flow through the coil 304 controls which end of the core 302 is the magnetic “north” pole and which end of the core 302 is the magnetic “south” pole. The coil 304 represents any suitable conductive structure through which an electrical current can flow to create an electromagnetic field in the core 302, such as wound wire.

The aperture mechanism here includes two blades 306-308, a cover plate 310, and a base plate 312. The cover plate 310 can be secured to the base plate 312 to thereby define a space between the plates 310-312 for the blades 306-308. The blades 306-308 can move back and forth within this space to alter the size of the aperture 208. Each blade 306-308 includes a semicircular cutout 314, and the cutouts 314 collectively form the smaller aperture 208. Note that semicircular cutouts and circular apertures are for illustration only, and cutouts and apertures could have any other desired shape(s). Also note that the blades 306-308 could have unequal cutouts, or a single blade could have a cutout.

Each blade 306-308 includes any suitable structure defining a portion of an aperture and configured to be moved to change the size of an aperture. Each blade 306-308 could be formed from any suitable material(s) and in any suitable manner. In some embodiments, the blades 306-308 are formed from metal(s) or other thermally conductive material(s) to help maintain a substantially uniform temperature across the blades 306-308 and covered with sputtered gold. In particular embodiments, the blades 306-308 are formed from beryllium copper and covered with sputtered gold.

The cover plate 310 and the base plate 312 include any suitable structures for covering the blades of an aperture mechanism. The cover plate 310 could perform other functions, such as shielding the blades 306-308 from radiation loading and providing a cold conductive path. The base plate 312 could also perform other functions, such as defining the larger size of the aperture 208 and providing a cold conductive path. Each plate 310-312 could be formed from any suitable material(s) and in any suitable manner. In some embodiments, the plates 310-312 are formed from metal(s) or other thermally conductive material(s), such as stainless steel alloy. In particular embodiments, the plates 310-312 are formed from NITRONIC 60.

As shown in FIG. 3, each plate 306-308 is connected to a magnet holder 316, which is secured to that plate using a pin 318. Each magnet holder 316 receives and retains a magnet 320 in a desired orientation. For example, the magnet holder 316 can retain the magnet 320 so that the magnetic north pole of the magnet 320 faces one direction and the magnetic south pole of the magnet 320 faces another direction. The base plate 312 includes multiple passages 322 allowing the magnet holders 316 and associated magnets 320 to pass linearly through the base plate 312 during movement of the plates 306-308. Each magnet holder 316 includes any suitable structure for retaining a magnet. Each pin 318 includes any suitable structure for coupling a magnet holder to a blade. Note that any other suitable mechanism could be used to join a blade and a magnet holder, including forming the magnet holder integral with the blade. Each magnet 320 includes any suitable magnetic structure that can be moved by an electromagnetic motor.

The magnets 320 operate in conjunction with the motors 212a-212b to move the blades 306-308 back and forth. For example, to create a smaller aperture 208, the motors 212a-212b can generate electromagnetic fields with the appropriate north/south pole arrangements to push/pull the magnets 320 towards the center of the aperture mechanism 210. This moves the blades 306-308 inward and narrows the aperture 208. Once the blades 306-308 have moved inward and currents through the motors 212a-212b have stopped, the blades 306-308 can be held in place by the magnetic attraction of the magnets 320 to the nearby portions of the motor cores 302. Similarly, to create a larger aperture 208, the motors 212a-212b can generate electromagnetic fields with the appropriate north/south pole arrangements to push/pull the magnets 320 away from the center of the aperture mechanism 210. This moves the blades 306-308 outward and enlarges the aperture 208. Once the blades 306-308 have moved outward and currents through the motors 212a-212b have stopped, the blades 306-308 can again be held in place by the magnetic attraction of the magnets 320 to the nearby portions of the motor cores 302.

In this example, the cores 302 are curved so that each core 302 has a portion located adjacent to each magnet 320. That is, the motor 212a has a core 302 with one portion next to the magnet 320 of the blade 306 and one portion next to the magnet 320 of the blade 308. Similarly, the motor 212b has a core 302 with one portion next to the magnet 320 of the blade 306 and one portion next to the magnet 320 of the blade 308. In this arrangement, both motors 212a-212b can be used to move the blade 306, and both motors 212a-212b can be used to move the blade 308. Note, however, that each motor 212a-212b could have a core 302 located next to a single magnet 320. In that arrangement, one motor 212a can be used to move the blade 306, and another motor 212b can be used to move the blade 308.

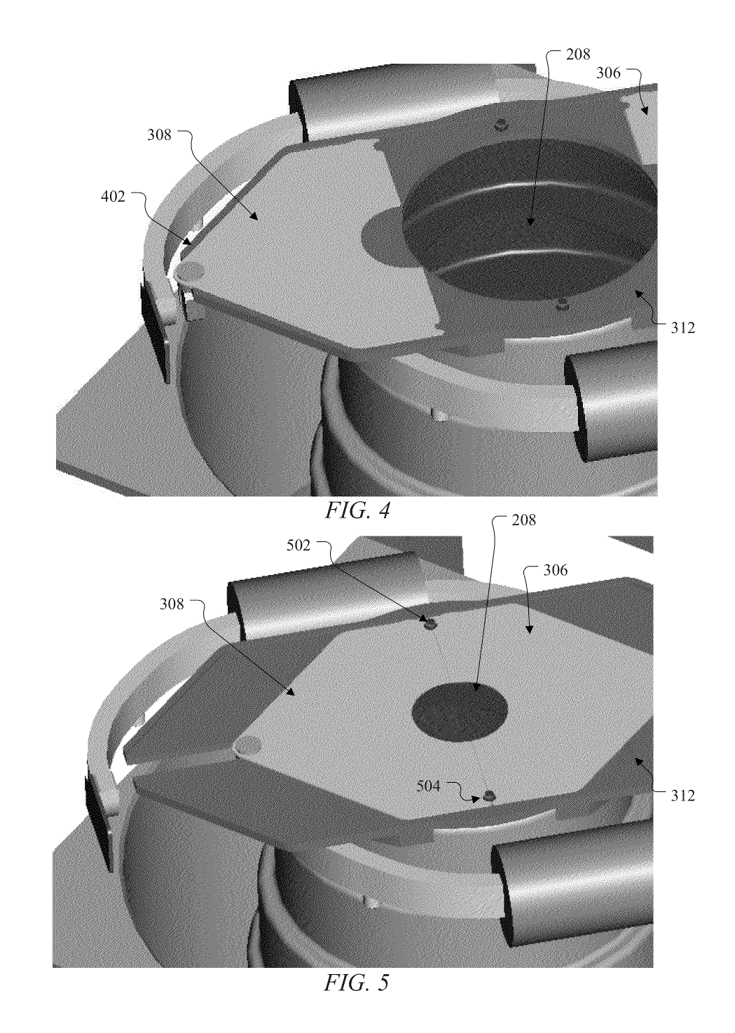

As shown in FIG. 4, the cover plate 310 has been removed for clarity. As shown here, the blades 306-308 of the aperture mechanism have been moved to their fully open position. In this position, the size of the aperture 208 is defined by the base plate 312 or by the underlying structure, and the blades 306-308 contact blade stops 402. The blade stops 402 represent raised portions of the base plate 312. In this example, the blade stops 402 are V-shaped to match the shape of the blades 306-308, although other shapes could be used (such as when the blades 306-308 have other shapes). The blade stops 402 can physically contact the blades 306-308 to stop movement of the blades 306-308. Moreover, because the blades 306-308 physically contact the blade stops 402, heat can be transferred between the blades 306-308 and the blade stops 402. This helps in the thermal management of the blades' temperature.

As shown in FIG. 5, the cover plate 310 has again been removed for clarity. As shown here, the blades 306-308 of the aperture mechanism have been moved to their fully closed position. In this position, the size of the aperture 208 is defined by the cutouts on the blades 306-308, and the blades 306-308 contact stop pins 502. The stop pins 502 denote structures that are connected to or part of the base plate 312. The stop pins 502 can be formed from any suitable material(s) and can have any suitable size and shape. The stop pins 502 can physically contact the blades 306-308 to stop the inward movement of the blades 306-308. Note that the blades 306-308 can include recesses 504 that match the shape of the stop pins 502, allowing the blades 306-308 to contact one another and block substantially all light except the light passing through the aperture 208. Moreover, because the blades 306-308 physically contact the stop pins 502, heat can be transferred between the blades 306-308 and the stop pins 502. This again helps in the thermal management of the blades' temperature.

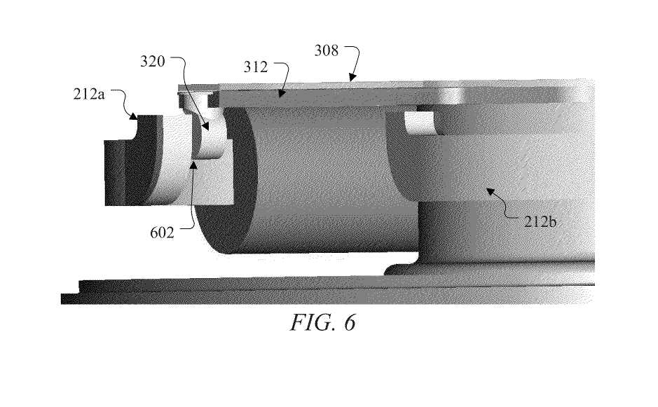

As shown in FIG. 6, the blades 306-308 of the aperture mechanism have again been fully opened. In FIG. 6, the magnet 320 attached to the blade 308 is separated from the core of the nearby motor 212a by a gap 602. This gap 602 exists because the blade stop 402 of the base plate 312 prevents the magnet 320 from moving closer to the motor 212a. Even when the motor 212a is turned off, the magnet 320 is magnetically attracted to the core of the motor 212a, helping to keep the blade 308 locked in place. The presence of the gap 602 helps to ensure that no physical contact occurs between the motor 212a and the blade 308. This again helps in the thermal management of the blade's temperature since no physical thermal conduction path exists between the motor 212a and the blade 308. Note that a similar gap exists between the blade 308 and the motor 212b when the blades 306-308 are closed.

In FIG. 6, the blade 308 is moved by controlling the magnetic north and south poles of each motor 212a-212b. For example, assume the magnet 320 attached to the blade 308 is oriented so that its magnetic north pole faces outward and its magnetic south pole faces inward. To move the blade 308 outward, the directions of currents through the coils of the motors 212a-212b are controlled so that the motor 212a has a magnetic south pole near the magnet 320 and so that the motor 212b has a magnetic south pole near the magnet 320. As a result, the motor 212a pulls the magnet 320 outward, and the motor 212b pushes the magnet 320 outward. Similarly, to move the blade 308 inward, the directions of currents through the coils of the motors 212a-212b are reversed so that the motor 212a has a magnetic north pole near the magnet 320 and so that the motor 212b has a magnetic north pole near the magnet 320. In this configuration, the motor 212a pushes the magnet 320 inward, and the motor 212b pulls the magnet 320 inward. The magnet 320 attached to the blade 306 can have an opposite orientation so that its magnetic north pole faces inward and its magnetic south pole faces outward. The blade 306 would therefore move in the same manner (inward or outward) as the blade 308 with the same magnetic poles created by the motors 212a-212b.

As noted above, the blades 306-308 can be coated with sputtered gold, and the plates 310-312 can be formed from NITRONIC 60 or other stainless steel alloy. This helps to significantly reduce the friction experienced by the blades 306-308 and plates 310-312. Among other things, this can help to reduce wear on the blades 306-308 and plates 310-312. This can also help to increase the ability to precisely control the temperature of the blades 306-308, since less friction results in less heat. Moreover, these benefits can be obtained regardless of whether the aperture system 206 operates in air or a vacuum, and the aperture system 206 may not be affected by the presence of moisture. In addition, devices using sputtered gold and NITRONIC 60 or other stainless steel alloy components can be fabricated much quicker than devices that use exotic hard coatings, which can take extended periods of time (such as weeks or even months) to fabricate.

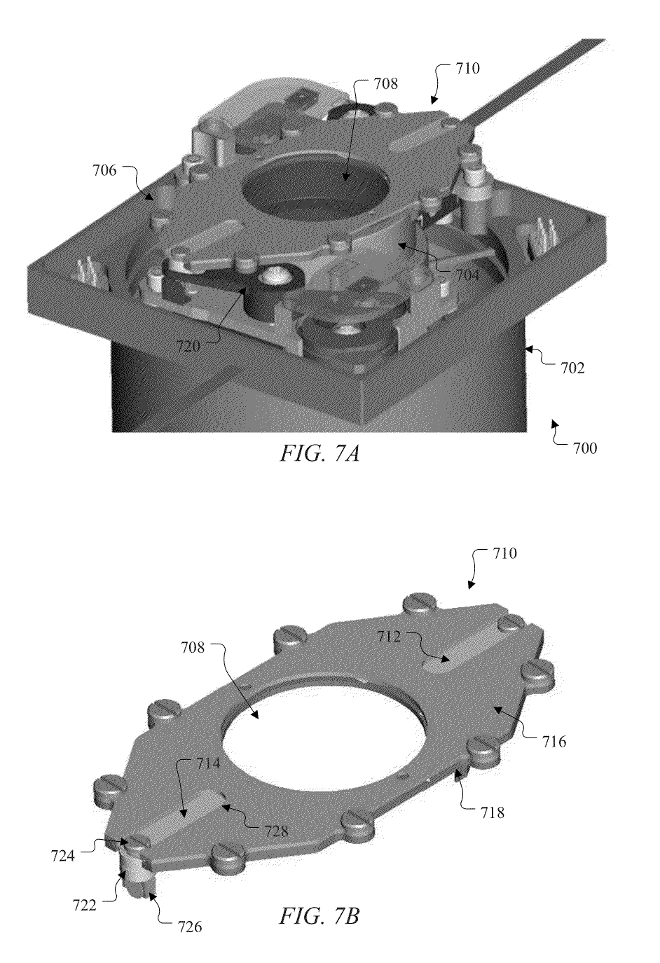

FIGS. 7A and 7B illustrate another example imaging device 700 with a variable aperture mechanism in accordance with this disclosure. In this example, the device 700 includes a housing 702, a cooling system 704, and an aperture system 706 defining an aperture 708. The aperture system 706 includes an aperture mechanism 710 that adjusts the size of the aperture 708. The aperture mechanism 710 includes two blades 712-714, a cover plate 716, and a base plate 718.

The aperture mechanism 710 differs from the aperture mechanism 210 in how the blades 712-714 are moved. Rather than using magnets and electromagnetic motors, the aperture mechanism 710 uses motors 720 that contact rollers 722 that are attached to the blades 712-714. The motors 720 are used to push and pull the rollers 722 to thereby move the blades 712-714 back and forth. Screws 724 secure the rollers 722 between the blades 712-714 and roller stops 726, although other mechanisms can be used to connect the rollers 722 to the blades 712-714. The blades 712-714 and the roller stops 726 hold the rollers 722 in a position to contact the motors 720. Both the cover plate 716 and the base plate 718 include passages 728 allowing movement of the screws 724 and the rollers 722 back and forth as the blades 712-714 move.

The motors 720 include any suitable structures for causing movement of rollers connected to blades of an aperture mechanism. In this example, the motors 720 include arms with openings for receiving the rollers 722, where the openings allow the rollers 722 to move as the blades 712-714 are moved. The rollers 722 include any suitable structures that roll along other structures. In particular embodiments, the rollers 722 include heat-treated TORLON roller drive bushings, which can contact the stainless steel alloy of the base plate 718. The use of the rollers 722 in this manner converts sliding friction associated with conventional devices into rolling friction, which can help to reduce the overall friction experienced by the blades 712-714.

As noted above, the blades 712-714 can be coated with sputtered gold, and the plates 716-718 can be formed from NITRONIC 60 or other stainless steel alloy. This helps to significantly reduce the friction experienced by the blades 712-714 and plates 716-718. Among other things, this can help to reduce wear on the blades 712-714 and plates 716-718. This can also help to increase the ability to precisely control the temperature of the blades 712-714, since less friction results in less heat. Moreover, these benefits can be obtained regardless of whether the aperture system 706 operates in air or a vacuum, and the aperture system 706 may not be affected by the presence of moisture. In addition, devices using sputtered gold and NITRONIC 60 or other stainless steel alloy components can be fabricated much quicker than devices that use exotic hard coatings, which can take extended periods of time to fabricate.

Although FIGS. 2A through 7B illustrate examples of imaging devices with variable aperture mechanisms and related details, various changes may be made to FIGS. 2A through 7B. For example, the aperture systems 206, 706 shown here could be used with any suitable device or system and is not limited to use with the imaging devices 200, 700. Also, various components in FIGS. 2A through 7B could be combined into an integral unit or further subdivided, and each component could have any suitable size, shape, and dimensions. Further, multiple smaller apertures could be supported by the aperture system 206, 706. For instance, the aperture system 206, 706 could include multiple pairs of blades 306-308, 712-714, where each pair is associated with a different smaller aperture. These different pairs of blades could be actuated using different motors, allowing one of multiple aperture sizes to be created.

FIG. 8 illustrates an example method 800 for reducing friction and wear in cryogenic mechanisms and other systems in accordance with this disclosure. As shown in FIG. 8, gold is sputtered onto a first device component at step 802, and a second device component is formed (at least partially) using a stainless steel alloy at step 804. This could include, for example, performing ion sputtering to deposit sputtered gold onto the blades of an adjustable aperture mechanism or other device component(s). This could also include using NITRONIC 60 or other stainless steel alloy to form at least part of the plates of an adjustable aperture mechanism or other device component(s). The device components are assembled to form a completed device at step 806. This could include, for example, forming an imaging device with the blades positioned between and contacting the plates.

The device is operated at step 808, and the device components move against each other with reduced friction and wear at step 810. This could include, for example, operating the imaging device to repeatedly move the blades of the adjustable aperture mechanism back and forth between the plates of the aperture mechanism. This can be done any number of times, including hundreds of thousands of times, over the lifespan of the aperture mechanism. The presence of the sputtered gold and the stainless steel alloy on different components that contact one another can significantly reduce the friction and wear on those devices, thereby significantly increasing the operational lifespan of the device.

Although FIG. 8 illustrates one example of a method 800 for reducing friction and wear in cryogenic mechanisms and other systems, various changes may be made to FIG. 8. For example, different parties could perform different steps in the process. For instance, one or more parts suppliers could perform steps 802-804, a device manufacturer could perform step 806, and an end user could perform steps 808-810. Also, while shown as a series of steps, various steps in FIG. 8 could overlap, occur in parallel, occur in a different order, or occur any number of times.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a first component comprising a first surface, the first surface comprising sputtered gold; and
a second component comprising a second surface, the second surface comprising a stainless steel alloy;
wherein the first surface is configured to contact the second surface, and wherein one of the components is configured to move against another of the components.

2. The apparatus of claim 1, wherein the stainless steel alloy consists of a UNS 21800 or AISI Type S21800 metal.

3. The apparatus of claim 1, wherein the sputtered gold comprises ion sputtered gold.

4. The apparatus of claim 1, wherein the sputtered gold has a thickness of about 1 micron.

5. The apparatus of claim 1, wherein:
the first component comprises a first blade of an adjustable aperture mechanism, the adjustable aperture mechanism also comprising a second blade; and
the second component comprises a first plate of the adjustable aperture mechanism, the adjustable aperture mechanism further comprising a second plate;
wherein the blades are configured to move within a space between the plates.

6. The apparatus of claim 5, further comprising:
rollers connected to the blades; and
motors configured to contact the rollers in order to move the blades back and forth.

7. The apparatus of claim 5, wherein all surfaces of each blade that contact the plates comprise sputtered gold.

8. A method comprising:
obtaining a first component comprising a first surface, the first surface comprising sputtered gold;
obtaining a second component comprising a second surface, the second surface comprising a stainless steel alloy; and
placing the first surface of the first component into contact with the second surface of the second component;
wherein one of the components is configured to move against another of the components.

9. The method of claim 8, wherein the stainless steel alloy consists of a UNS 21800 or AISI Type S21800 metal.

10. The method of claim 8, wherein the sputtered gold comprises ion sputtered gold.

11. The method of claim 8, wherein the sputtered gold has a thickness of about 1 micron.

12. The method of claim 8, wherein:
the first component comprises a first blade of an adjustable aperture mechanism, the adjustable aperture mechanism also comprising a second blade; and
the second component comprises a first plate of the adjustable aperture mechanism, the adjustable aperture mechanism further comprising a second plate;
wherein the blades are configured to move within a space between the plates.

13. The method of claim 12, wherein all surfaces of each blade that contact the plates comprise sputtered gold.

14. A method comprising:
operating a device comprising a first component and a second component, the first component having a first surface comprising sputtered gold, the second component having a second surface comprising a stainless steel alloy; and
moving one of the components against another of the components while the first surface is contacting the second surface.

15. The method of claim 14, wherein the stainless steel alloy consists of a UNS 214800 or AISI Type S214800 metal.

16. The method of claim 14, wherein the sputtered gold comprises ion sputtered gold.

17. The method of claim 14, wherein the sputtered gold has a thickness of about 14 micron.

18. The method of claim 14, wherein:
the first component comprises a first blade of an adjustable aperture mechanism, the adjustable aperture mechanism also comprising a second blade;
the second component comprises a first plate of the adjustable aperture mechanism, the adjustable aperture mechanism further comprising a second plate; and
the blades move within a space between the plates.

19. The method of claim 18, wherein:
rollers are connected to the blades; and
motors contact the rollers in order to move the blades back and forth.

20. The method of claim 18, wherein all surfaces of each blade that contact the plates comprise sputtered gold.
